(19) United States
(12) Patent Application Publication
(10) Pub. No.: US 2007/0079979 A1
(43) Pub. Date: Apr. 12, 2007

(54) Hand-held power tool auxiliary unit

(76) Inventor: Willy Braun, Neustetten (DE)

Correspondence Address: STRIKER, STRIKER & STENBY, 103 EAST NECK ROAD, HUNTINGTON, NY, 11743, US

(21) Appl. No.: 11/542,780

(22) Filed: Oct. 4, 2006

(30) Foreign Application Priority Data
Oct. 10, 2005 (DE) 10 2005 048 345.3

(51) Int. Cl. B25B 13/46

(52) U.S. Cl. 173/29

(57) ABSTRACT

A hand-held power tool auxiliary unit has an impact mechanism and a coupling unit provided for coupling the impact mechanism to a hand-held power tool.

### CROSS-REFERENCE TO A RELATED APPLICATION

The invention described and claimed hereinbelow is also described in German Patent Application 102005048345.3 filed on Oct. 10, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a hand-held power tool auxiliary unit.

Rotary hammers are known which can be used to drill holes for fastening systems, such as anchor connections, screw-threaded anchor connections, and/or dowel connections. To tighten the fastening systems, additional tools can be used, such as wrenches, ratchet wrenches, etc., and/or power tools, such as impact wrenches in particular.

### SUMMARY OF THE INVENTION

It is an object of the present invention to provide an auxiliary unit for a hand-held power tool.

The present invention provides a hand-held power tool auxiliary unit for a hand-held power tool with an impact mechanism and a coupling unit, which is provided for coupling the impact mechanism to a hand-held power tool.

Using the hand-held power tool auxiliary unit, a functionality of the hand-held power tool can be advantageously expanded with the addition of an impact function. During operation, the impact mechanism can be driven by a drive unit of the hand-held power tool, thereby eliminating the need for a separate drive unit for the hand-held power tool auxiliary unit. The hand-held power tool auxiliary unit can therefore be lightweight, compact, and cost-effective in design.

The impact mechanism can be driven, in particular, by a rotating output element of the hand-held power tool, such as an output shaft. For example, the hand-held power tool auxiliary unit can be used in combination with a rotary hammer, a drill, a screwdriver, or any other type of hand-held power tool with a rotary output. The coupling unit can advantageously serve to fasten the hand-held power tool auxiliary unit to the hand-held power tool, to guide the hand-held power tool auxiliary unit during installation of the hand-held power tool auxiliary unit, and/or to transfer an output torque to the impact mechanism. In this context, the term “provided” should be understood to mean “specially designed” and/or “specially equipped”.

The impact mechanism advantageously includes a rotary impact mechanism. In this manner, the functionality of the hand-held power tool can be advantageously expanded with the addition of an impact wrench function. During operation, pulses can be transmitted in the direction of rotation to a rotating tool that is driven by the hand-held power tool auxiliary unit. This is particulary suitable for tightening and/or loosening tight screwed connections. The rotary impact mechanism can be designed, e.g., as a V-grooving impact mechanism or as a cam-driven impact mechanism.

It is also provided that the impact mechanism includes a drive shaft unit, and the coupling unit includes at least one coupling region, which is integral with the drive shaft unit. Additional coupling parts and installation effort can be spared, which allows the hand-held power tool auxiliary unit to be lightweight and compact in design. In addition, direct transmission—or transmission without the use of additional transmission elements—of an output torque to the impact mechanism can be attained. The coupling region extends a coupling length in the axial direction, and the drive shaft unit advantageously extends at least two coupling lengths in the axial direction, by way of which distance can be bridged advantageously using few components.

In a further embodiment of the present invention, the coupling unit is provided for fastening the impact mechanism to the hand-held power tool using a joining motion. As a result, a rapid, simple and tool-free installation of the hand-held power tool auxiliary unit on the hand-held power tool can be attained. In this context, the term “joining motion” should be understood to mean an insertion or removing motion.

When the coupling unit includes at least one detent element, a particularly compact and comfortable design of the coupling unit can be attained in this context.

It is furthermore provided that the coupling unit is provided for coupling the impact mechanism to a tool fitting. As a result, existing tool interfaces can be used for the coupling unit. For example, the coupling unit can be provided with a socket element that includes a socket geometry of an SDS-Plus tool insertion end or an octagon. The SDS-Plus System (Special Direct System) is an insertion system developed by Robert Bosch GmbH for insertion tools, in particular drilling and/or percussive tools. A tool fitting equipped with the SDS-Plus System includes driving wedges and locking elements, e.g., locking bearings. A tool insertion end provided with the SDS-Plus System includes grooves that extend in the longitudinal direction of the tool insertion end and, in interaction with the driving wedges and the locking elements, serve to transmit torque or to automatically lock the tool after it is inserted.

When the hand-held power tool is provided with a replaceable tool fitting, the coupling unit can include a coupling region that includes a socket geometry of the tool fitting. As a result, the number of rotating parts can be advantageously reduced.

Advantageously, the coupling unit includes at least one adapter unit, which is fixable to the impact mechanism. As a result, flexibility of use of the hand-held power tool auxiliary unit can be attained. With the aid of adapter units that include different socket geometries, an impact mechanism can be used in combination with several different types of hand-held power tools.

When the hand-held power tool auxiliary unit includes a switchable transmission unit, the hand-held power tool auxiliary unit can be easily adapted to conditions of use, e.g., by the user selecting a speed and/or torque suitable for the application. When the hand-held power tool auxiliary unit includes a rotary impact mechanism, it is also provided in this context that the rotary impact mechanism can be switched on and off. When the rotary impact mechanism is switched off, the hand-held power tool can be used with its main functionality, with greater flexibility due to the switchable transmission unit.

When the hand-held power tool auxiliary unit includes a fixing element for fixing a handle in position, a handle can be easily installed, which can offer advantageous support of the hand-held power tool auxiliary unit during operation and effective guidance of the hand-held power tool auxiliary unit during its installation. For example, a handle that belongs to the hand-held power tool can be used advantageously to support the hand-held power tool auxiliary unit.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a spindle region of a rotary hammer and an impact wrench attachment module with a rotary impact mechanism,

FIG. 2 shows the impact wrench attachment module mounted on the rotary hammer,

FIG. 3 shows a drill and an alternative impact wrench attachment module with an SDS-Plus insertion end,

FIG. 4 shows an impact wrench attachment module with an adapter, and

FIG. 5 shows a further impact wrench attachment module with a rotary impact mechanism that can be switched on and off.

### DESCRIPTION OF THE PREFERRED EMBODIMENTS

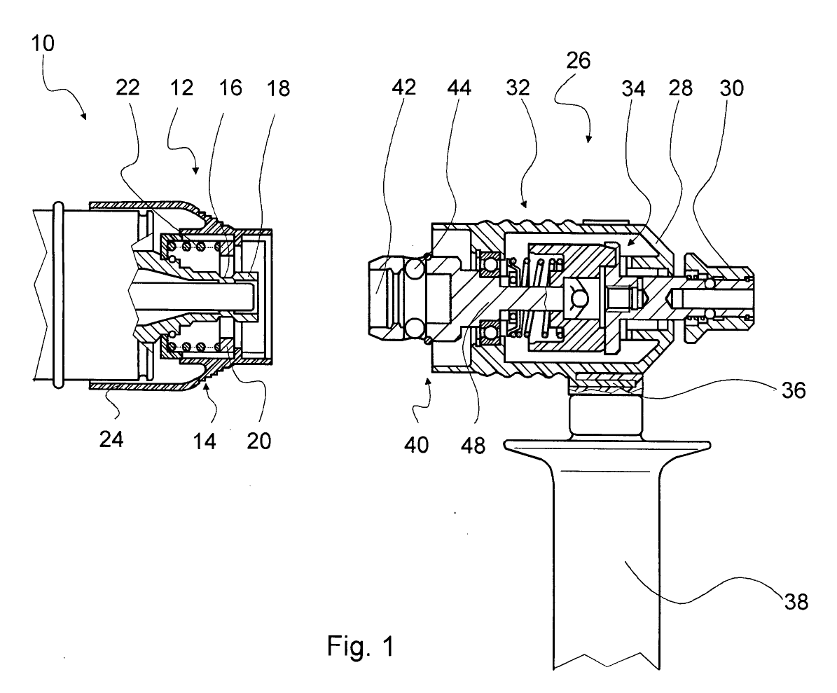

FIG. 1 shows a spindle region of a hand-held power tool 10 designed as a rotary hammer. It includes a receiving area 12—which is shown in a sectional view—for receiving a replaceable tool fitting, which is not shown in the figure. To lock and unlock the tool fitting, receiving area 12 is provided with a locking device 14, which includes a recess 16 of a tool unit 18 designed as a hammer tube, a locking ring 20, a spring 22, and an actuating sleeve 24.

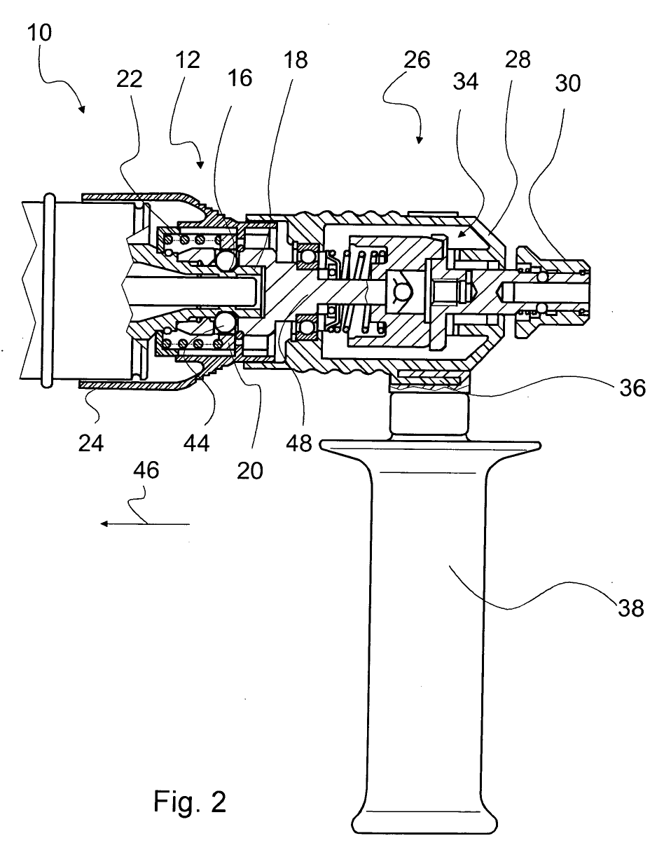

In addition, a hand-held power tool auxiliary unit—designed as an impact wrench attachment module 26—for the rotary hammer is shown in a sectional view. The hand-held power tool auxiliary unit is shown in its installed state in FIG. 2. It includes a housing 28, a tool fitting 30, and an impact mechanism 32 with a rotary impact mechanism 34, which is designed as a V-grooving impact mechanism. The principle, design, and mode of operation of a V-grooving impact mechanism is known, and will not be described in greater detail. The hand-held power tool auxiliary unit is held by a handle 38. To this end, the hand-held power tool auxiliary unit includes a fixing element 36, which is designed to create a spring-groove connection with handle 38. As an alternative or in addition thereto, further fixing elements, such as detent elements, are feasible for fixing hand-held power tool auxiliary unit to handle 38. Using the hand-held power tool auxiliary unit, the functionality of the rotary hammer can be expanded with the addition of an impact wrench function.

The hand-held power tool auxiliary unit is provided with a coupling unit 40 to couple impact mechanism 32 with the rotary hammer. Coupling unit 40 includes a sleeve-shaped coupling region 42 into which tool unit 18 designed as a hammer tube engages when the hand-held power tool auxiliary unit is in the installed state. To lock the hand-held power tool auxiliary unit to the rotary hammer, coupling unit 40 also includes two detent elements 44 designed as locking bearings. When the hand-held power tool auxiliary unit is in the attached state, detent elements 44 are engaged in recess 16 of tool unit 18, and locking ring 20 prevents detent elements 44 from disengaging. Locking ring 20 is held in its locking position by spring 22.

The design of coupling unit 40 allows the hand-held power tool auxiliary unit to be fastened to hand-held power tool 10 quickly and tool-free via insertion into receiving area 12 of hand-held power tool 10. During insertion, coupling area 42 is guided onto tool unit 18 designed as a hammer tube until detent elements 44 engage in recess 16 and thereby lock the hand-held power tool auxiliary unit in position. To unlock the hand-held power tool auxiliary unit, actuating sleeve 24 is slid in unlocking direction 46, by way of which locking ring 20 is moved into a position that releases the hand-held power tool auxiliary unit.

When the rotary hammer is operated with the hand-held power tool auxiliary unit installed, impact mechanism 32 is driven by a drive unit of the rotary hammer. A torque output by tool unit 18 designed as a hammer tube is transmitted to coupling area 42 coupled with tool unit 18. Coupling area 42 is integrally moulded to a drive shaft unit 48 of impact mechanism 32. As a result, direct transmission of the torque output by tool unit 18 to impact mechanism 32 can be attained without the use of intermediate elements.

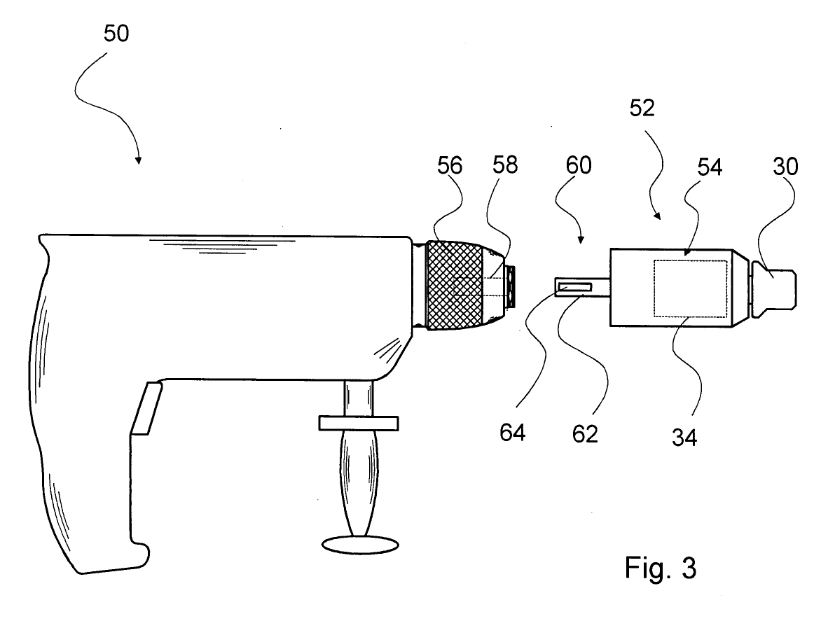

A hand-held power tool 50 designed as a drill, and a hand-held power tool auxiliary unit for the drill are shown in FIG. 3. The hand-held power tool auxiliary unit is designed as an impact wrench attachment module 52 and includes an impact mechanism 54, which is provided with rotary impact mechanism 34 shown in FIG. 1. The drill includes a tool fitting 56, which includes a tool unit 58 designed as an SDS-Plus tool interface. The design and mode of operation of a tool interface of this type is known, and will not be described in greater detail here.

The hand-held power tool auxiliary unit is provided with a coupling unit 60 to couple impact mechanism 54 with tool fitting 56. Coupling unit 60 includes an insertion element 62 that is designed in accordance with an SDS-Plus insertion end and includes a closed groove 64 for automatic locking to tool unit 58. Using this insertion element 62, the hand-held power tool auxiliary unit can be easily attached via insertion into tool fitting 56 on the drill.

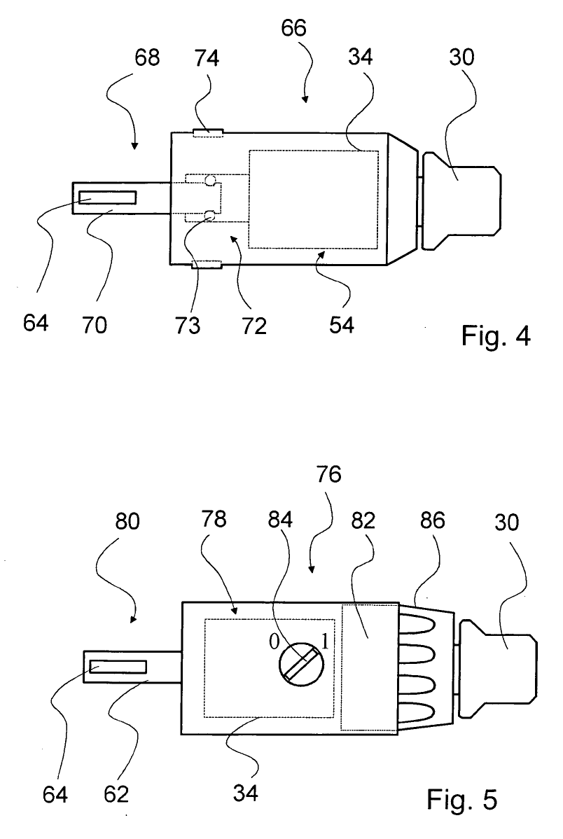

A further embodiment of a hand-held power tool auxiliary unit is shown in FIG. 4. It is designed as an impact wrench attachment module 66 and is designed in accordance with the hand-held power tool auxiliary unit shown in FIG. 3. Identical parts are labeled with the same reference numerals. A coupling unit 68 includes an adapter unit 70 designed as an insertion element. It is attached to impact mechanism 54 using a fastening device 72 of impact mechanism 54, which is provided with detent elements 73.

Adapter unit 70 is designed such that it can be detached from impact mechanism 54. To release adapter unit 70, fastening device 72 includes actuating elements 74, by means of which detent elements 73 can be moved into a position that releases adapter unit 70. Further locking and unlocking mechanisms that appear reasonable to one skilled in the art for locking and unlocking adapter unit 70 are feasible. Further adapter units are also feasible that have various socket geometries, e.g., an insertion element with an octagon. Using these adapter units, impact mechanism 54 can be attached to different types of tool fittings.

A further embodiment of a hand-held power tool auxiliary unit, which is designed as an impact wrench attachment module 76 for the drill, is shown in FIG. 5. It includes an impact mechanism 78 with rotary impact mechanism 34 shown in FIG. 1, a coupling unit 80, and a transmission unit 82 designed as a manual transmission. In addition, the hand-held power tool auxiliary unit is provided with a hammer stop function. To this end, the hand-held power tool auxiliary unit includes an actuating element 84, via which rotary impact mechanism 34 can be switched on and off by an operator. The operator can also adjust an output speed of impact mechanism 78, using an adjusting ring 86 of transmission unit 82.

When the drill with the hand-held power tool auxiliary unit and the switched-off rotary impact mechanism 34 is operated, adjusting ring 86 can be used, e.g., to select an output speed that is suitable for a drilling task. It is also feasible to manufacture the hand-held power tool auxiliary unit in different graduated sizes, which are matched to different torque ranges designed for certain applications.

It will be understood that each of the elements described above, or two or more together, may also find a useful application in other types of constructions differing from the type described above.

While the invention has been illustrated and described as embodied in a hand-held power tool auxiliary unit, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hand-held power tool auxiliary unit, comprising an impact mechanism; and a coupling unit configured for coupling said impact mechanism to a hand-held power tool.

2. A hand-held power tool as defined in claim 1, wherein said impact mechanism includes a rotary impact mechanism.

3. A hand-held power tool as defined in claim 1, wherein said impact mechanism includes a drive shaft unit, while said coupling unit includes at least one coupling region which is integral with said drive shaft unit.

4. A hand-held power tool as defined in claim 1, wherein said coupling unit is configured for attaching said impact mechanism to the hand-held power tool using a joining motion.

5. A hand-held power tool as defined in claim 4, wherein said coupling unit includes at least one detent element.

6. A hand-held power tool as defined in claim 1, wherein said coupling unit is configured for coupling said impact mechanism to a tool fitting.

7. A hand-held power tool as defined in claim 1, wherein said coupling unit includes at least one adaptor unit which is fixable to said impact mechanism.

8. A hand-held power tool as defined in claim 1; and further comprising a switchable transmission unit.

9. A hand-held power tool as defined in claim 1, wherein said impact mechanism is configured so that it is switchable on and switchable off.

10. A hand-held power tool as defined in claim 1; and further comprising a handle; and a fixing element for fixing said handle.

11. A hand-held power tool, comprising a tool unit; and a detachable hand-held power tool auxiliary unit, said auxiliary unit including an impact mechanism and a coupling unit configured for coupling said impact mechanism to said tool unit.
